(19) United States
(12) Patent Application Publication
(10) Pub. No.: US 2008/0032273 A1
(43) Pub. Date: Feb. 7, 2008

(54) Anatomical model

(75) Inventors: Francis T. Macnamara, Newton, MA (US); Matthew Whitney, Upton, MA (US); Dana Constant, Watertown, MA (US); Luis J. Maseda, Natick, MA (US); Roman Tunkel, Arlington, MA (US); William Lucas Churchill, Bolton, MA (US); Peter L. Dayton, Brookline, MA (US); James Duronio, Westford, MA (US); Robert Eiermann, Ashland, MA (US); Mary Ann Scalaro, Brimfield, MA (US)

Correspondence Address: KLARQUIST SPARKMAN, L.L.P.;MICHAEL P. GIRARD, 121 S.W. SALMON STREET, SUITE 1600, PORTLAND, OR, 97204, US

(73) Assignee: Boston Scientific Scimed, Inc.

(21) Appl. No.: 11/820,802

(22) Filed: Jun. 19, 2007

Related U.S. Application Data
(60) Provisional application No. 60/815,626, filed on Jun. 21, 2006.

(51) Int. Cl. G09B 23/28

(52) U.S. Cl. 434/262

(57) ABSTRACT

An anatomical model for simulating internal body structures of a patient, which in one embodiment includes a shell that simulates a body cavity and a length of animal tissue that simulates an organ in the body cavity. A sheath surrounds the animal tissue and is secured at one or more anchor points in the shell to support the animal tissue in the shell. In one embodiment, one or more force sensors are positioned to detect forces on the animal tissue or the shell.

### RELATED APPLICATION

The present application claims the benefit of U.S. Provisional Application No. 60,815,626, filed Jun. 21, 2006, which is herein incorporated by reference.

### FIELD

The following disclosure relates to anatomical models, and in particular to models for simulating internal body cavities.

### BACKGROUND

Anatomical models are well known devices for teaching doctors or other medical personnel about the human body. Such models are often made of plastic or latex and are shaped to simulate the structure of human bones, organs, or other anatomical systems and structures. The models are used to allow students to identify various body parts as well as to practice medical procedures prior to use on a living patient. In addition, such models are often used by medical device developers in order to test various designs and/or aspects of medical devices.

One such anatomical model is a model of a human colon. Endoscopists and students often use such models to practice various intubation and procedure techniques inside the model. While plastic or latex models can be fashioned to have the same shape as an actual human colon, such models generally do not interact with an endoscope in the same way that actual colon tissue does, and therefore do not provide a completely realistic simulation.

### SUMMARY

The present disclosure describes an anatomical model for simulating internal body structures of a patient. In one embodiment, the model simulates a human colon. A torso shell has an inner shape that conforms to a typical human body cavity in which a colon is found. A tubular fabric sheath supports a length of colon tissue that is obtained from an animal. The colon tissue is placed in the sheath and is secured at one or more anchor points in the torso shell. An inflatable bladder pressurized to a variable pressure is placed against the colon tissue to simulate abdominal pressure on the colon. A cover seals the inflatable bladder and colon tissue in the torso shell.

In one embodiment, an artificial cecum is secured to the distal end of the colon tissue. The cecum may include one or more polyp holders that hold one or more simulated polyps so that a physician can practice removing them during a medical procedure.

In one embodiment, the anatomical model is secured to a base that includes one or more force sensors and position sensors. The sensors can measure forces on the model or the position of an endoscope as it is used in the model.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of the disclosed technology will become more readily appreciated as the same become better understood by reference to the following detailed description, when taken in conjunction with the accompanying drawings, wherein:

FIG. 1 illustrates an anatomical model in accordance with an embodiment of the disclosed technology;

FIG. 2 illustrates a length of animal tissue placed in the anatomical model in accordance with an embodiment of the disclosed technology;

FIG. 3 illustrates one placement of colon tissue in a torso shell in accordance with an embodiment of the disclosed technology;

FIG. 4 illustrates one embodiment of a simulated cecum in accordance with an embodiment of the disclosed technology; and

FIG. 5 illustrates an anatomical model including a number of sensors in accordance with an embodiment of the disclosed technology.

### DETAILED DESCRIPTION

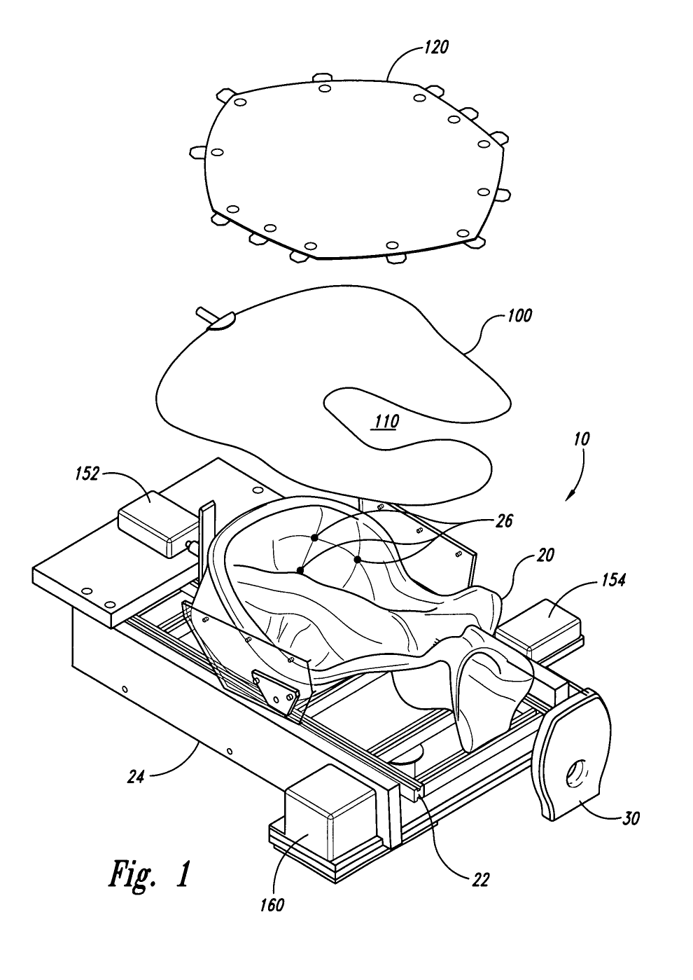

FIG. 1 illustrates one embodiment of an anatomical model in accordance with the disclosed technology. In the embodiment shown, the model 10 includes a torso shell 20 having an inner surface shape which simulates a typical human body cavity in which a colon and intestines are located. One suitable torso shell is available from Steinbeis Transfer Center Healthcare Technologies of Tubingen, Germany. In one embodiment, the torso shell 20 is secured to a rack 22 that is mounted on one or more ball bearings. The rack is fitted within a frame 24 such that the rack has some movement fore and aft as well as from side to side on the bearings. The inner surface of the torso shell 20 also includes a number of anchor points 26 positioned at various locations in the shell. The anchor points 26 may include snaps, rivets, Velcro® pads, magnets, anchoring holes, etc., that allow the position of a colon model to be fixed at selected locations in the torso shell. An anal pad 30 fits at the end of the pelvic girdle on the torso shell 20 and secures a length of animal tissue, as will be explained below. In one embodiment, the anal pad 30 is made of a foam rubber.

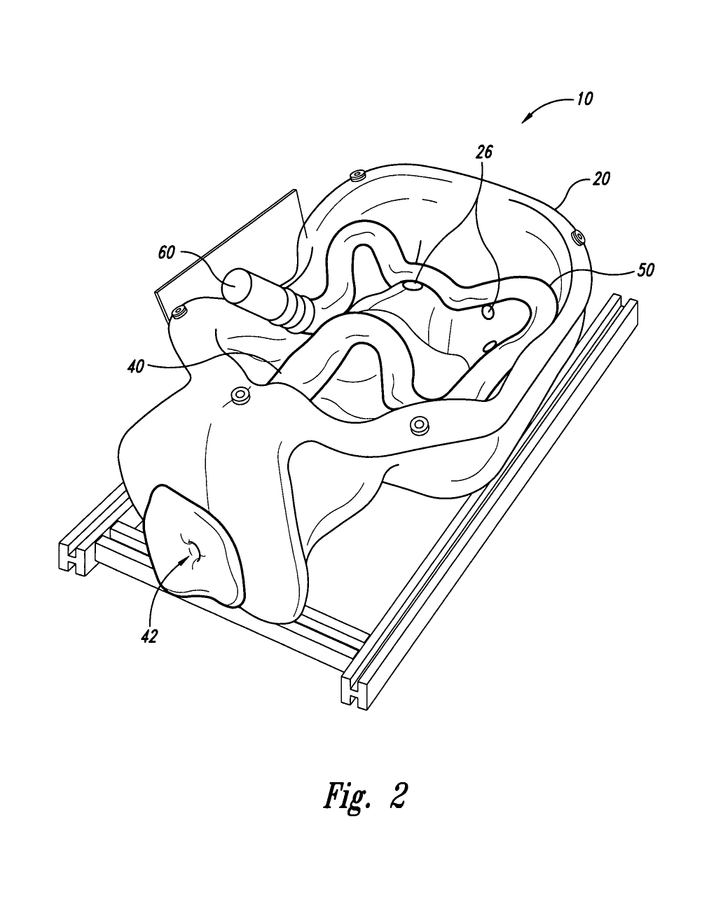

As shown in FIG. 2, a length of animal colon tissue 40 including a section of tissue surrounding an anus 42 is placed in the torso shell 20. The animal colon is generally available from meat processors and is cut to a length of approximately 60 inches. The tissue surrounding the anus 42 is secured to the anal pad 30 with wire clips, cords, adhesive, or the like. In addition, an O-ring may be placed over the colon tissue in the area of the anus 42 to further simulate the closing of the anus 42. All or a portion of the colon tissue extending inside the torso shell 20 is surrounded by a fabric sheath or sock 50 that simulates the mesentery tissue that holds the colon in place within the body cavity. The sheath may comprise a single type of material or a combination of different materials joined together having different stretch or other characteristics. In one embodiment, the fabric sheath 50 is formed of a nylon stocking material. The sheath 50 may have a constant or varying diameter. The distal end of the colon tissue 40 may be sealed shut or may be fitted with an artificial cecum 60 that simulates the end of the colon.

In another embodiment, the sheath comprises an elastic sleeve (such as polymer sheet or natural or synthetic fabric) that is pre-shaped in the desired anatomical form with a plurality of securing features at desired locations along the geometry of the elastic sleeve. There is at least one securing feature of a desired geometry per desired location along the elastic sleeve geometry. The securing features may be of the same or different material as the elastic sleeve, and all securing features need not be of the same geometry or material. The elastic sleeve further has an enclosed, or semi-enclosed, conduit or cavity that can be accessed by various means (zipper, hook and loop, buttons, etc.) to introduce biological material to be housed in sleeve. The biological material may be in turn secured to sleeve or allowed to move freely within the cavity. The elastic sleeve is attached to the desired torso shell (or pliable cover) locations via one or many of the securing features at each attachment point along the elastic sleeve. Attaching more or less of the securing features at each site influences the elastic sleeve's mobility, or increases the force required to stretch feature with respect to torso anchor point. Securing more features would make it more difficult to stretch elastic sleeve away from anchor point. The colors of the elastic sleeve could be such that they mimic desired simulated anatomy. The pre-formed shape of the elastic sleeve can be that of bowel, or other anatomy of interest.

To simulate different colon shapes in a patient, the supporting fabric sheath 50 is secured to the inside surface of the torso shell 20 at one or more of the anchor points 26. Fasteners on the supporting sheath 50 cooperate with the snap fittings, magnets, Velcro pads, screw holes, or other fastening mechanisms on the anchor points 26 allow the colon tissue 40 to be supported at desired positions within the torso shell 20. The fasteners may be flexible to allow the sheath to move with respect to the anchor points 26 in order to simulate the response of a colon during a colonoscopy. Flexible fasteners may be made of a polymeric material such as rubber posts, bolts, rivets, wraps, or the like that are secured to the anchor points.

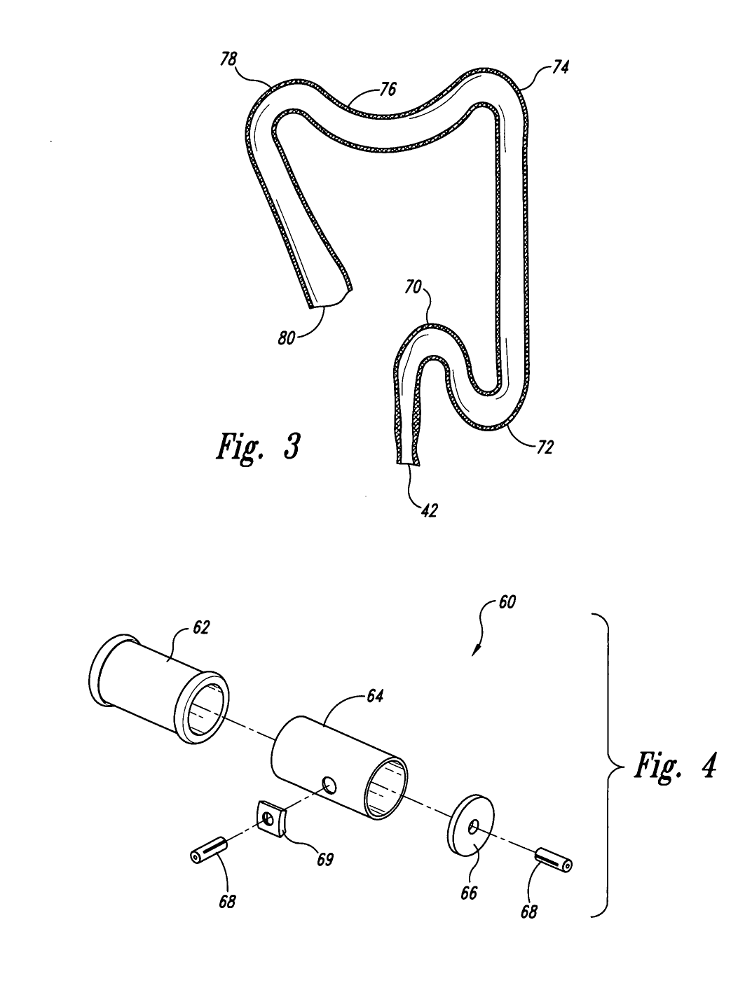

FIG. 3 illustrates one two-dimensional layout of the animal colon tissue in the torso shell 20 that simulates the arrangement of a human colon. Beginning at the anus 42, the colon tissue 40 extends in a relatively straight fashion into the torso shell for a distance of approximately 6 inches to simulate the rectum. Joining the simulated rectum is a bend 70 that extends almost 180° downward and to the right (when viewed from the front) with a radius of curvature of approximately 2 inches to simulate the sigmoid colon. A second bend 72 of approximately 180° connects to the bend 70 and leads to a length of tissue that simulates the descending colon. The descending colon region extends in a generally straight direction upwards in the torso shell for a distance of approximately 16 inches to a bend 74 that simulates the splenic flexure. The colon tissue then extends leftward at the bend 74, having a radius of curvature of approximately 2 inches to connect to a length of tissue that simulates the transverse colon. In the embodiment shown, the transverse colon is anchored by the supporting sheath such that it has a U-shaped bend 76 whereby the ends of the “U” are higher in the body cavity than the middle. In one embodiment, the U-shaped bend 76 has a radius of curvature of approximately 16 inches. The transverse colon then extends to a bend 78 representing the hepatic flexure having a radius of curvature of approximately 2 inches that turns the colon tissue approximately 180° downward, leading to a length of colon tissue that simulates the ascending colon. The length of tissue that simulates the ascending colon is approximately 9 inches long.

Returning to FIG. 1, an inflatable bladder 100 is one mechanism for applying pressure to the colon tissue to simulate other tissue and organs surrounding the colon. In the embodiment shown, the inflatable bladder 100 is a generally U-shaped ring having a center portion 110 that does not inflate and an outer radius having an inflatable chamber that extends around the perimeter of the body cavity defined by the torso shell 20. The inflatable bladder 100 may be inflated with air or a gas, or may be filled with a liquid material. The level of inflation can be adjusted to simulate different pressures on the colon as may be encountered in various body types. The inflatable bladder 100 may include a single inflatable chamber or may include two or more inflatable chambers. Each inflatable chamber can be inflated to a desired level to simulate pressure from different organs on the colon tissue or different colonoscopy cases.

In one embodiment, the inflatable bladder 100 is secured in the torso shell 20 with a cover 120. In one embodiment, the cover 120 includes a number of snap fittings that are secured to corresponding snap fittings positioned around the rim of the torso shell 20. In the embodiment shown, the cover 120 and inflatable bladder 100 are separate components. However, it will be appreciated that these components may be combined if desired. For example, the inflatable bladder may include straps that allow it to be secured to the torso shell 20.

In one embodiment of the invention, the cover 120 is made of a pliable material, such as vinyl or rubber that allows an endoscope passing through the colon tissue 40 to be felt underneath the inflatable bladder 100. By pressing on the cover 120, a nurse or other user can attempt to prevent the endoscope from looping as is done during a conventional colonoscopy procedure.

FIG. 4 illustrates an embodiment of the artificial cecum 60 that may be secured to the end of the animal colon tissue. In this embodiment, the cecum 60 includes a cecum adapter 62 that comprises a tube of plastic material such as acetal. A pair of raised rims are positioned at the ends of the tube allow the colon tissue to be placed over a rim and secured with a rubber band, zip tie, or the like. A cecum body 64 is made of a tube of a lower durometer material such as natural rubber, latex, or the like. The cecum body 64 is affixed to the adapter 62 by sliding one end over a raised rim of the cecum adapter 62. An end cap 66 is fitted into the end of the cecum body 64 and secured with an adhesive or the like. The end cap may include a hole into which a polyp holder 68 can be fitted. In one embodiment, the polyp holder is a tube having a number of longitudinal slots within the sidewalls. The slots form fingers that can be compressed to hold a simulated polyp made from animal tissue or other substance therein. One or more polyp holders 68 may be fitted to extend into the sidewall of the cecum body 64. A passage plate 69 may be used to provide support for the polyp holder 68. With the polyp holders 68 in place, an endoscopist or student can practice removing the simulated polyp from the polyp holder with a snare and vacuum or similar tools.

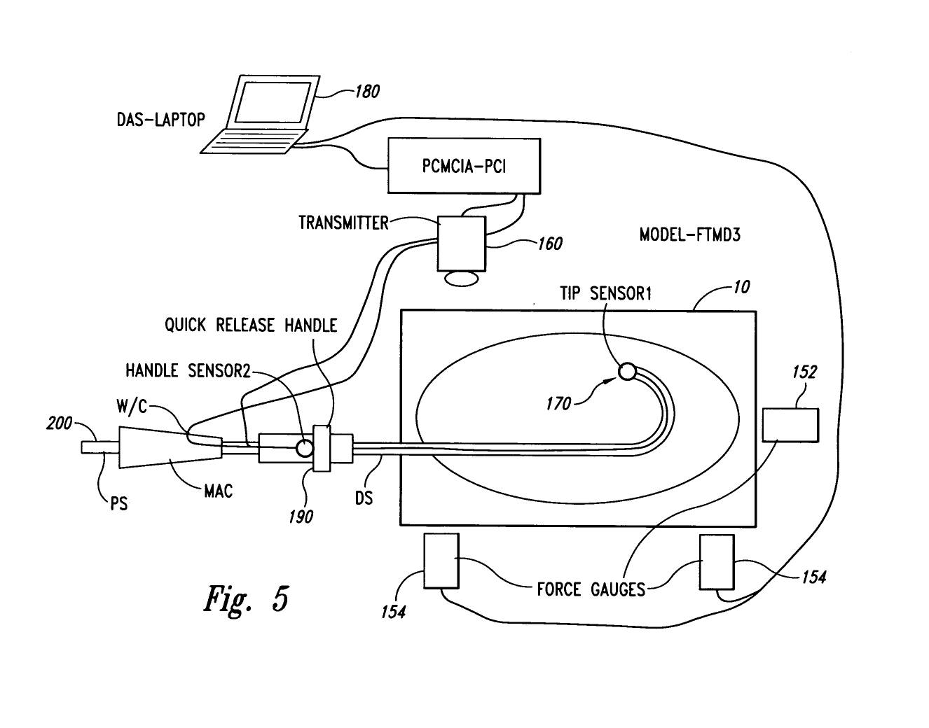

The anatomical model 10 described above also allows a determination of forces applied as a physician/trainee uses an endoscope in the colon tissue. An instrumented model allows a determination to be made of a colon model complexity based on the forces measured during intubation, extraction or during an entire colonoscopy procedure. As shown in FIG. 5, the anatomical model 10 may be coupled to a number of force gauges 152, 154. The force gauge 152 is generally positioned in line with an endoscope 200 that is inserted into the anus of colon tissue. The force gauges 154 are positioned on one or both sides of the model to detect lateral forces on the colon tissue. In addition, the one or more transmitters 160, such as a magnetic field generator, can be used to transmit electromagnetic or other signals that are picked up by a sensor 170 such as a three-dimensional coil sensor positioned within the endoscope. The combination of the transmitter 160 and sensor 170 allow the position of the distal tip to be detected. A sensor 190 is positioned over the shaft of the endoscope between the endoscope handle and the distal tip of the endoscope.

Signals from the transmitter/receiver pair 160, 170 and the force gauges 152, 154 can be fed to a computer system 180 to provide a real time plot of the position of the endoscope and forces on the colon tissue. Signals from the force gauges 152, 154, as well as from the position sensors 160, 170, and 190, allow the interaction forces between the endoscope and the colon to be analyzed. For example, it is possible to compare various endoscope designs for ease in trackability through the colon tissue. Similarly, readings from these sensors can be detected to alert a physician/trainee as to the likelihood that a procedure or action will cause patient discomfort or potential injury. The computer system 180 can be programmed to compare forces and/or positions of the endoscope to one or more limits and provide alarm signals or other indications to the endoscopist or trainee that too much force is being applied or that the endoscope is not in the correct position, etc. In another embodiment, force sensors are placed on both the proximal and distal ends of the endoscope. The sensors can measure axial and torsional loads at both locations and this data can be used to understand and predict how forces are transmitted through the endoscope.

Because the colon tissue 40 is harvested from an animal that closely mimics human tissue, the images observed by the physician will closely approximate those seen during a human endoscopy. Generally an endoscopist navigates his or her way around the tortuous human colon by following the darker area in their view. Therefore the model should produce images on a screen that are very similar to what a doctor will see during a human colonoscopy. Furthermore, because the tissue is wet, movement of the endoscope through the colon tissue closely simulates how the endoscope will perform during a human colonoscopy. Although colon tissue in the disclosed embodiment of the model is obtained from pigs, it will be appreciated that other animal tissue, such as from sheep, may be used.

Another advantage of the model disclosed is that it allows the colon shape to be changed. By selectively securing portions of the supporting fabric sheath to the torso shell, configurations can be set up that mimic a male colon, a female colon, or colon tissue that has undergone or is surrounded by tissue that has undergone a surgical procedure or is otherwise unusually shaped. Furthermore, the anatomical model 10 allows the colon walls to stretch by including a number of folds in the fabric sheath. The amount of stretch can also be varied by using a sheath material of different durometers in order to simulate how certain portions of the colon stretch as the colonoscope is passed through. Similarly, the anchor points or fasters that couple the sheath to the anchor points can have varying levels of elasticity to simulate looping that can occur during a colonoscopy procedure. By selectively placing anchor points for the fabric sheath in the torso, loops such as a double alpha loop or a reverse double alpha loop in the sigmoid region can be simulated. Similarly, a 3D curvature in the splenic and hepatic flexures can also be simulated. Finally, features such as restrictions, polyps, folds, etc., can be fashioned or placed into the colon walls by cutting or suturing the colon wall or by adhering objects or injecting dyes to the colon wall.

Upon completion of a training session, the anatomical model 10 can be taken apart and the colon tissue 40 disposed of. The remaining components can be cleaned for re-use.

While illustrative embodiments have been illustrated and described, it will be appreciated that various changes can be made therein without departing from the scope of the invention. For example, the anatomical model can be adapted for simulating other body cavities. Esophagus tissue from an animal such as a pig can be placed in a shell that simulates an upper respiratory cavity. Furthermore, the anatomical model described above can be used to simulate body cavities in animals in addition to humans. Such a model may be useful for veterinary students or for manufacturers of veterinary medical devices. Furthermore, the model may be used as a training and development tool for surgical endoscopy and NOTES (natural orifice transluminal endoscopic surgery) to provide realistic access and closure for physicians and trainees. Further, this invention can be used for testing of endoscopic devices such as balloons, stents and snares, etc. Therefore, the scope of the invention is to be determined from the following claims and equivalents thereof.

The embodiments of the invention in which an exclusive property or privilege is claimed are defined as follows:

1. An anatomical model, comprising:
a torso shell;
a sheath for supporting a length of animal tissue within the torso shell;
an inflatable member that is selectively inflated to apply pressure to the animal tissue within the torso shell; and
a cover that maintains the inflatable member and the sheath within the torso shell.

2. The model of claim 1, wherein the model is an anatomical colon model.

3. The model of claim 1, wherein the sheath supports the animal tissue in the torso shell at a number of anchor points and the sheath includes a number of fasteners that are securable to the one or more anchor points in the torso shell.

4. The model of claim 3, wherein the fasteners are flexible.

5. The model of claim 2, wherein the animal tissue is a length of pig colon tissue.

6. The model of claim 5, wherein the pig colon tissue includes an anus.

7. The model of claim 2, further comprising a cecum model adapted to be secured to an end of the animal tissue.

8. The model of claim 7, wherein the cecum model includes a flexible tube and an adapter that joins the flexible tube to the length of animal tissue.

9. The model of claim 7, wherein the cecum model includes one or more polyp adapters for holding a section of animal tissue to simulate a polyp.

10. The model of claim 9, wherein the polyp adapters comprise a cylinder having one or more longitudinal slots formed therein that allow the walls of the cylinder to receive the simulated polyp.

11. The model of claim 9, wherein the adapter comprises a tube having a raised lip at each end over which the length of animal tissue and the flexible tube of the cecum can be fitted.

12. The model of claim 1, wherein the cover is made of a pliable material.

13. The model of claim 1, wherein the sheath comprises a length of nylon fabric.

14. The model of claim 1, wherein the sheath comprising sections of fabric having different stretch characteristics.

15. The model of claim 1, further comprising one or more sensors that detect forces on the model.

16. The model of claim 15, wherein the torso shell is mounted on a rack having one or more bearings that allow the rack to move within a frame and the sensors are force sensors positioned against the torso shell.

17. The model of claim 1, further comprising a magnetic field generator and a magnetic field sensor that are positioned to detect the location of an endoscope in the model.

18. The model of claim 1, wherein the inflatable member includes two or more chambers that are separately inflatable.

19. An anatomical model, comprising:
a shell having an internal shape of a body cavity and a number of anchor points at which a sheath can be secured;
a sheath for supporting a length of animal tissue that simulates a body lumen; and
a number of fasteners that hold the sheath at selected anchor points in the shell to simulate different configurations of a body lumen.

20. The model of claim 19, further comprising a cover secured to the shell to hold the sheath, animal tissue, and inflatable member in the shell.

21. The model of claim 19, further comprising an inflatable member that is positioned over the sheath and is inflatable against the sheath and animal tissue;

22. The model of claim 21, wherein the inflatable member includes two or more chambers that are separately inflatable.

23. The model of claim 19, further comprising one or more force sensors positioned to detect forces on the animal tissue in the shell.

24. The model of claim 19, wherein the sheath includes a fabric tube.

25. The model of claim 19, wherein the sheath includes two or more sections of fabric having different stretch characteristics.
